(19) United States
(12) Patent Application Publication
(10) Pub. No.: US 2021/0148303 A1
(43) Pub. Date: May 20, 2021

(54) COOLING STRUCTURE OF ENGINE

(71) Applicant: MAZDA MOTOR CORPORATION, Hiroshima (JP)

(72) Inventors: Daisuke MATSUMOTO, Aki-gun (JP); Hiroaki MURANAKA, Aki-gun (JP); Daisuke TABATA, Aki-gun (JP); Masaki TAKAHARA, Aki-gun (JP)

(73) Assignee: MAZDA MOTOR CORPORATION, Hiroshima (JP)

(21) Appl. No.: 17/011,305

(22) Filed: Sep. 3, 2020

(30) Foreign Application Priority Data
Nov. 18, 2019 (JP) 2019-207721

(51) Int. Cl. F02F 1/14; F01P 3/02

(52) U.S. Cl. CPC F02F 1/14; F02F 1/108; F01P 3/02

(57) ABSTRACT

A cooling structure of an engine comprises a cylinder block provided with a wall surface partitioning a water jacket provided to surround a cylinder line and allow cooling water to flow therein and a water-jacket spacer arranged inside the water jacket and provided to regulate flowing of the cooling water. The water-jacket spacer comprises a spacer body having a shape along an outer-peripheral shape of the cylinder line and includes an internal surface facing cylinders, and an expansive member expandable according to an external factor is provided at the internal surface of the spacer body such that the expansive member extends continuously over a range from an one-end side to the other-end side of the cylinder line at a lower part, in a cylinder-axis direction, of the internal surface of the spacer body.

### BACKGROUND OF THE INVENTION

The present invention relates to a cooling structure of an engine, comprising a water-jacket spacer which is arranged inside a water jacket of an engine block and provided to regulate flowing of cooling water.

The water jacket, as a flow passage of the cooling water, is provided at the engine block of a multi-cylinder type of internal combustion engine such that the cooling water flows through a cylinder wall, that is—a bore central wall which is a peripheral wall of each cylinder and an inter-bore wall which is a wall interposed between adjacent cylinders. The water-jacket spacer provided to regulate flowing of the cooling water may be arranged inside the water jacket. The temperature of the bore central wall and the inter-bore wall can be set at a target value by regulating the cooling-water flowing.

In general, the water-jacket spacer separates the flow passage of the cooling water into a bore-side passage which is close to the cylinders and an anti-bore-side passage which is far from the cylinders. Japanese Patent Laid-Open Publication No. 2016-180314 discloses a technology that an expansive member which is configured to expand through its contacting with the water is attached to a bore-side wall surface (internal surface) of the water-jacket spacer. This expansive member is arranged over a range from a lower end to an upper end, in a cylinder-axis direction, of the water-jacket spacer at a position which faces the bore central wall. This expansive member is configured to close a gap between the water-jacket spacer and the bore central wall when it has expanded, whereby the flowing of the cooling water is regulated. Thereby, excessive cooling of the bore central wall can be suppressed.

There is a concern that there may occur some natural convection which is generated between the above-described bore-side passage and the above-described anti-bore-side flow passage, which are separated by the water-jacket spacer, and causes the excessive cooling of the cylinder wall. For example, when the engine stops, the temperature of the cooling water in the bore-side passage becomes relatively high because this cooling water contacts the cylinder wall, whereas the temperature of the cooling water in the anti-bore-side passage becomes relatively low because of the heat exchange of this cooling water with the outside air. This kind of temperature difference of the cooling water may cause the natural convection occurring between the bore-side passage and the anti-bore-side passage.

The technology of arranging the expansive member disclosed in the above-described patent document may be useful in suppression of the above-described improper natural convection. However, it has been found that the above-described arrangement of the expansive member over the range from the lower end to the upper end, in the cylinder-axis direction, of the water-jacket spacer at the position which faces the bore central wall as disclosed in the patent document is insufficient in order to perfectly suppress the natural convection of the cooling water.

### SUMMARY OF THE INVENTION

An object of the present invention is to provide a cooling structure of an engine which can properly suppress the natural convection of the cooling water from occurring between an internal surface and an external surface of the water-jacket spacer inside the water jacket.

The present invention is a cooling structure of an engine, comprising an engine block provided with a wall surface which partitions a cylinder line including plural cylinders arranged in a specified direction and a water jacket provided to surround the cylinder line and allow cooling water to flow therein, and a water-jacket spacer arranged inside the water jacket and provided to regulate flowing of the cooling water in the water jacket, wherein the water-jacket spacer comprises a spacer body which has a shape along an outer-peripheral shape of the cylinder line and includes an internal surface facing the cylinders and an external surface positioned on an opposite side to the internal surface, and an expansive member configured to be expandable according to an external factor is provided at the internal surface of the spacer body of the water-jacket spacer such that the expansive member extends continuously over a range from an one-end side of the cylinder line to the other-end side of the cylinder line at a lower part, in a cylinder-axis direction, of the internal surface of the spacer body.

According to the present invention, the natural convection of the cooling water can be properly suppressed from occurring between the internal surface and the external surface of the spacer body inside the water jacket by means of the expansive member which is provided at the internal surface of the spacer body. That is, the expansive member is provided to extend continuously over the range from the one-end side of the cylinder line to the other-end side of the cylinder line at the internal surface of the spacer body. Accordingly, the expansive member fills the gap between the internal surface of the spacer body and the cylinder wall of the engine block over an entire length of the cylinder line when it has expanded, so that occurring of the natural convection of the cooling water can be suppressed. Further, the expansive member is provided at the lower part, in the cylinder-axis direction, of the internal surface of the spacer body. Thereby, the heated cooling water can be made to stay in an upper part located above the above-described lower part of the internal space of the spacer body where the expansive member is not arranged. Accordingly, moving (flowing) of the cooling water between the internal surface of the spacer body and the external surface of the spacer body, i.e., the natural convection of the cooling water is suppressed from occurring properly, so that the heat retaining property of the cylinders can be improved.

In an embodiment of the present invention, the above-described cooling structure of the engine further comprises a piston provided to reciprocate in the cylinder-axis direction inside each cylinder and including a skirt portion, wherein the lower part, in the cylinder-axis direction, of the internal surface of the spacer body where the expansive member is provided is an area which is configured to face a part of the wall surface of the engine block which is located below a lower end of the skirt portion of the piston when the piston is positioned at a top dead center.

In general, an area from the upper end of the cylinder to the lower end of the skirt portion of the piston positioned at the top dead center becomes an area of a heat source where the heat is generated through the combustion occurring inside the cylinder. According to this embodiment, since the heated cooling water can be made to stay in a part which faces this heat-source area, the heat retaining property of the hear-source area can be improved.

In another embodiment of the present invention, the engine block comprises an inter-bore wall which is interposed between adjacent cylinders and a bore central wall which is another part of a peripheral wall of each cylinder than the inter-bore wall, and thickness, in a direction perpendicular to the specified arrangement direction of the plural cylinders in a horizontal plane, of the expansive member in an expanded state of the expansive member is set such that the expansive member is capable to close a gap between the internal surface of the spacer body of the water-jacket spacer and the inter-bore wall and the bore central wall of the engine block.

According to this embodiment, the gap between the internal surface of the spacer body and the inter-bore wall and the bore central wall of the engine block can be securely closed with the expansive member when the expansive member has expanded. Accordingly, the occurring of the natural convection of the cooling water can be securely suppressed over the entire length of the cylinder line.

In another embodiment of the present invention, the water-jacket spacer is configured to separate a flow passage of the cooling water inside the water jacket into a bore-side passage which is close to the cylinders and an anti-bore-side passage which is far from the cylinders, and the water-jacket spacer is arranged inside the water jacket such that a lateral width of the bore-side passage is narrower than that of the anti-bore-side passage.

According to this embodiment, since the lateral width of the bore-side passage is set to be narrower than that of the anti-bore-side passage, a structure in which the flowing of the cooling water is difficult to occur in the bore-side passage can be provided. Accordingly, the suppression performance of the natural convection by means of the expansive member can be promoted.

In another embodiment of the present invention, a part of the expansive member which is provided to face the both cylinders located at the one-end side of the cylinder line and the other-end side of the cylinder line is provided not only at the lower part, in the cylinder-axis direction, of the internal surface of the spacer body but at an upper part of the internal surface of the spacer body which is located above the lower part.

Since the cylinders located at the one-end side of the cylinder line and the other-end side of the cylinder line are positioned at both ends of cylinder line, these cylinders tend not to receive the heat influence caused by the combustion of the other cylinders very much. Therefore, according to this embodiment, contacting with the cooling water regarding these cylinders is properly avoided by providing the expansive member not only at the lower part, in the cylinder-axis direction, of the internal surface of the spacer body but at the upper part of the internal surface of the spacer body. Thereby, the heat retaining property of these cylinders can be improved properly.

The present invention will become apparent from the following description which refers to the accompanying drawings.

### BRIEF DESCRIPTION OF THE DRAWINGS

FIG. 1 is a front view of an engine to which an engine cooling structure according to the present invention is applied.

FIG. 2 is an exploded perspective view showing a cylinder block and a water-jacket spacer.

FIG. 3 is a sectional view of the cylinder block in an XY plane.

FIG. 4 is a sectional view taken along line IV-IV of FIG. 3.

FIG. 5 is a sectional view taken along line V-V of FIG. 3.

FIG. 6 is a perspective view of the water-jacket spacer.

FIG. 7 is a side view of an internal-surface side of the water-jacket spacer.

FIG. 8A is a sectional view showing flowing of cooling water when a water pump operates, FIG. 8B is a sectional view showing natural convection of the cooling water when the water pump stops.

FIG. 9A is a sectional view showing a state before an expansive member provided at the water-jacket spacer expands, FIG. 9B is a sectional view showing a state after the expansive member expands.

FIG. 10 is a side view of the internal-surface side of the water-jacket spacer, which shows relationships with cylinders.

FIGS. 11A-11C are diagrams showing the flowing of the cooling water when the water pump stops in cases where respective expansive members of comparative examples and the present embodiment are used.

FIG. 12 is a sectional view showing a preferred arrangement position of the expansive member provided at the water-jacket spacer.

### DETAILED DESCRIPTION OF THE INVENTION

[Entire Structure of Engine]

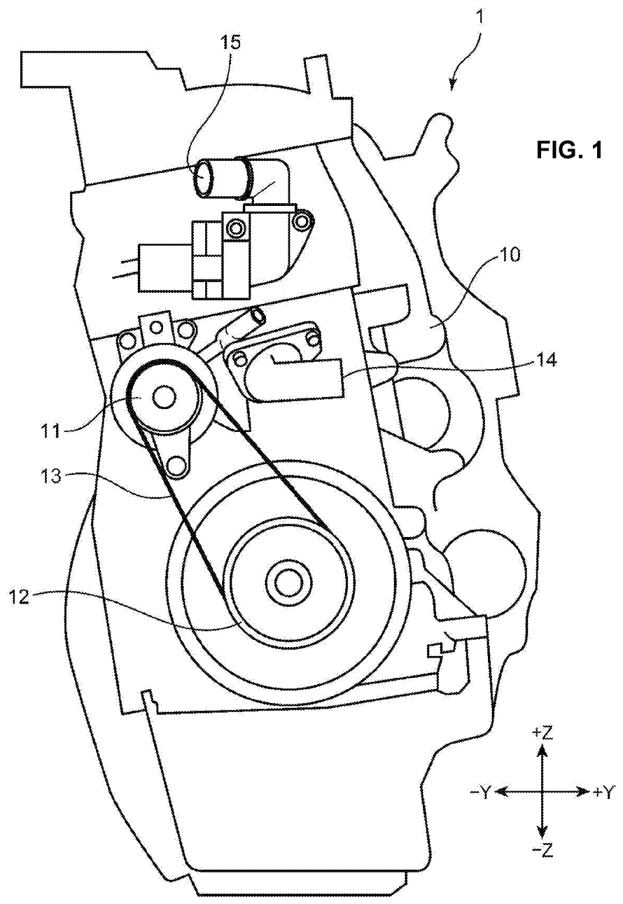

Hereafter, an embodiment of the present invention will be specifically described referring to the drawings. FIG. 1 is a front view of an engine 1 to which an engine cooling structure according to the present invention is applied. The engine 1 which is installed to a vehicle as a driving power source is a multi-cylinder four-cycle diesel engine, for example.

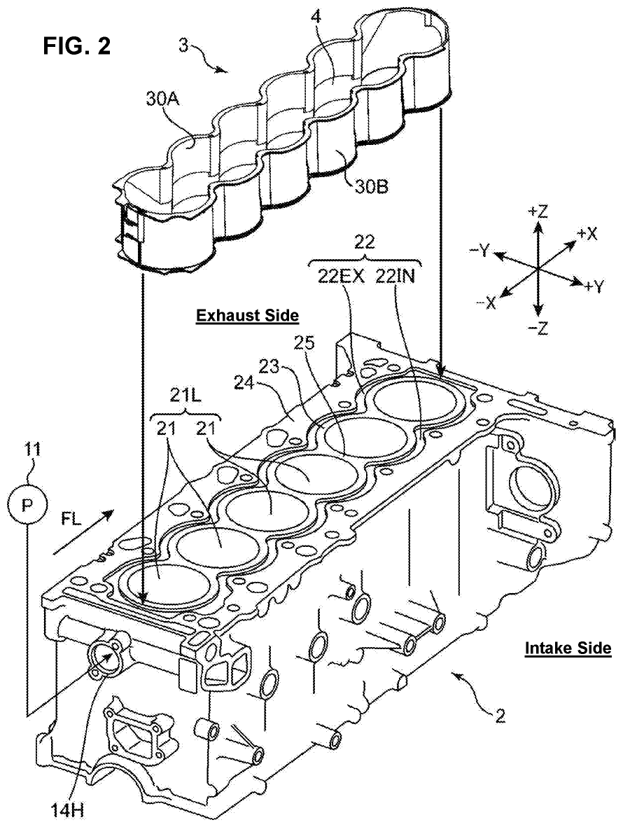

The engine 1 comprises an engine body 10 which includes a cylinder block 2 (engine block; FIG. 2) provided with plural cylinders, a cylinder head mounted onto an upper face of the cylinder block 2, and pistons stored inside the cylinders. The engine 1 is arranged longitudinally or laterally at the vehicle. In a case of the engine's longitudinal arrangement, a Y direction shows a lateral direction, whereas a Z direction shows a vertical direction (+Z=upper, −Z=lower) in FIG. 1.

The engine 1 is equipped with a water pump 11 for compulsorily circulating cooling water into the engine body 10. The water pump 11 is an impeller type of pump with an impeller to pressurize and supply the cooling water. The water pump 11 is driven by a driving force generated by the engine body 10. That is, the driving force of a crankshaft provided at the engine body 10 is transmitted to the water pump 11 via a crank pulley 12 which is attached to the crankshaft and a stretch belt 13 which is stretched between the water pump 11 and the crank pulley 12.

FIG. 1 shows a cooling-water inlet 14 to introduce the cooling water into the engine body 10 and a cooling-water outlet 15 to discharge the cooling water flowing through a flow passage formed inside the engine body 10. The water pump 11 is set into the flow passage of the cooling water. Herein, the cooling water not only flows down the flow passage of the engine body 10 but circulates in a circulating passage extending through a heater unit for heating, a radiator for heat radiation, and so on.

[Cooling Device of Cylinder Block]

FIG. 2 is an exploded perspective view showing a part of the flow passage which is positioned at the cylinder block 2 of the engine body 10. FIG. 2 shows the cylinder block 2 and a water-jacket spacer 3 which is installed to the cylinder block 2. The cylinder block 2 comprises a cylinder line 21L where six cylinders 21 are arranged in the X direction (specified direction) in line and a water jacket 22 which is a drain (groove) provided to surround the cylinder line 21L. The water jacket 22 forms the flow passage of the cooling water at the cylinder block 2. Herein, the X direction is a longitudinal direction of the vehicle in a case where the engine 1 is arranged longitudinally. The water-jacket spacer 3 is arranged inside the water jacket 22.

The cylinder block 2 is a substantially rectangular-parallelepiped block which in elongated in the X direction. A block-side inlet 14H which is an inlet of the cooling water flowing to the cylinder block 2 is provided at a side face of the cylinder block 2 which is positioned on the −X side. The block-side inlet 14H is connected to the cooling-water inlet 14 shown in FIG. 1. The cooling water flows into the water jacket 22 from the block-side inlet 14 by being pressurized and supplied by the water pump 11. Then, as shown by an arrow FL, the cooling water flows inside the water jacket 22 from the −X-side side face of the cylinder block 2 toward the +X-side side face of the cylinder block 2. That is, the water jacket 22 is the flow passage where the cooling water flows from a one-end side of the cylinder line 21L (the −X side) to the other-end side face of the cylinder line 21L (the +X side).

The cylinder head, not illustrated, is mounted onto the upper face (+Z face) of the cylinder block such that it closes over an upper-face opening of each cylinder of the cylinder line 21L. The cylinder head is provided with an intake port and an intake valve to supply intake air to each cylinder 21 and an exhaust port and an exhaust valve to exhaust combustion gas from each cylinder 21. FIG. 2 shows indications of an “intake side” where the respective intake valves are arranged and an “exhaust side” where the respective exhaust valves are arranged relative to an arrangement line of the cylinder line 21L (a line of the X direction). The water jacket 22 includes an intake-side jacket 22IN which is positioned on the intake side of the cylinder line 21L and an exhaust-side jacket 22EX of the cylinder line 21L.

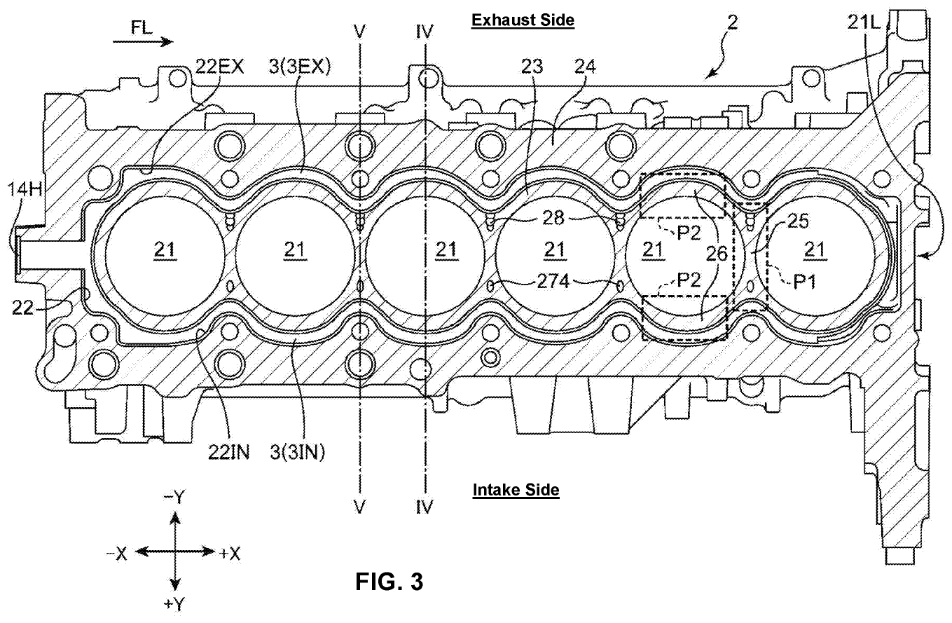

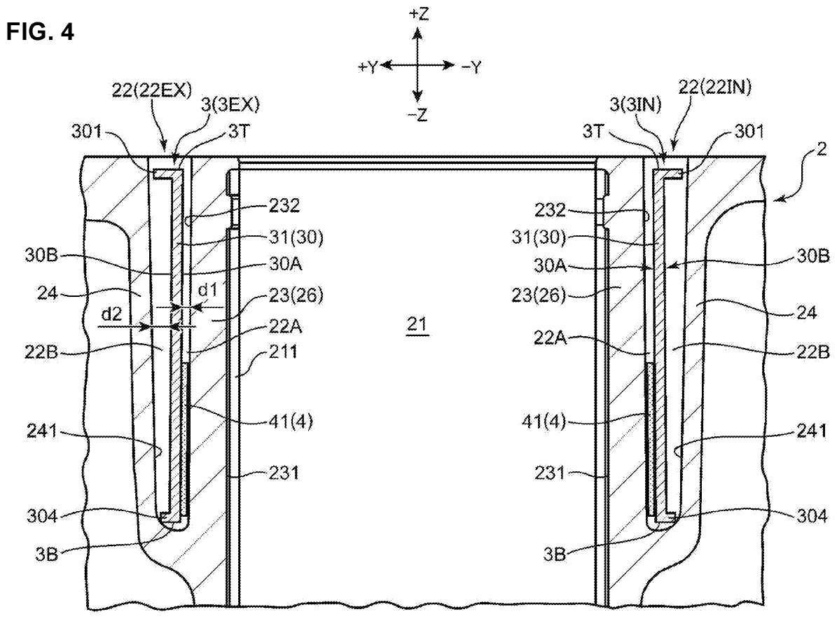

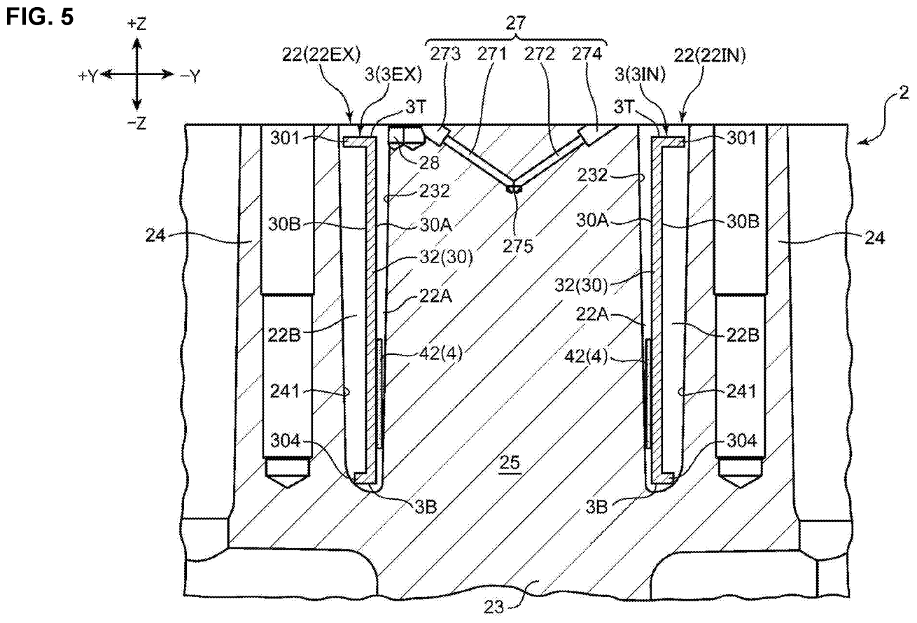

The cylinder block 2 will be described further specifically. FIG. 3 is a sectional view of the cylinder block 2 in an XY plane. FIG. 4 is a sectional view taken along line IV-IV of FIG. 3, and FIG. 5 is a sectional view taken along line V-V of FIG. 3. The cylinder block 2 includes an internal block 23 and an outside block 24 which is provided to surround the internal block 23. As shown in FIGS. 4 and 5, the internal block 23 includes an internal peripheral wall 231 which is a cylindrical wall surface partitioning the cylinder 21 and an external wall 232 which is a wall surface partitioning an internal surface of the water jacket 22.

The internal block 23 further comprises an inter-bore wall 25 and a bore central wall 26. The inter-bore wall 25 is a wall positioned in an area P1 substantially shown in FIG. 3, which is interposed between adjacent cylinders 21 in the X direction at the cylinder block 2. The inter-bore wall 25 receives heat from a heat source of the two adjacent cylinders 21, so that the temperature of this wall 25 tends to become high. The bore central wall 26 is a wall positioned in an area P2 substantially shown in FIG. 3, which is another part of a peripheral wall of the cylinder 21 than the inter-bore wall 25. That is, a pair of arc-shaped walls, positioned on the +Y side and the −Y side, of each cylinder 21 which is not positioned at both-side ends of the cylinder line 21L constitute (form) the bore-central wall 26, whereas another pair of arc-shaped walls, positioned on the +X side and the −X side, of each cylinder 21 constitute (form) the inter-bore wall 25. A liner 211 on which the piston, not illustrated, slides is arranged at the internal peripheral wall 231 of the internal block 23.

Referring to FIG. 5, a cross drill 27 as a flow passage of the cooling water is formed at the inter-bore wall 25. The cross drill 27 is provided to cool the inter-bore wall 25 which tends to have a high temperature, which is a penetrating hole extending across the inter-bore wall 25 in the Y direction (a direction perpendicular to a cylinder-line direction in a horizontal plane). The cross drill 27 has a flow-passage shape in which an upstream drill hole 271 which extends obliquely downwardly from the +Y side to the −Y side and a downstream drill hole 272 which extends obliquely downwardly from the −Y side to the +Y side join (merge) at a downstream side (a joining portion 275). A large-sized introduction opening 273 is provided at an upper end of the upstream drill hole 271, and a large-sized exit opening 274 is provided at an upper end of the downstream drill hole 272.

An inlet hole 28 is formed near an upper end of the external wall 232 of the internal block 23 which partitions the exhaust-side jacket 22EX. The inlet hole 28 is a hole for introducing the cooling water into the cross drill 27, which is connected to the introduction opening 273 of the cross drill 27. Meanwhile, the exit opening 274 of the cross drill 27 is not directly connected to the intake-side jacket 22IN. The exit opening 274 is connected to a water jacket which is provided at the cylinder head, not illustrated. The inter-bore wall 25 is configured such that its exhaust side has a higher temperature than its intake side. Accordingly, the exhaust side of the inter-bore wall 25 which tends to have the high temperature can be properly cooled by providing the inlet hole 28 at the external wall 232 partitioning the exhaust-side jacket 22EX.

The external block 24 includes an internal wall 241 which is a wall surface partitioning an internal surface of the water jacket 22. A gap between this internal wall 241 and the external wall 232 of the internal block 23 is a space of the water jacket 22 where the cooling water flows. The thickness of the internal block 23 is substantially constant in a radial direction of the cylinder 21, except the inter-bore wall 25. Accordingly, the external wall 232 of the internal block 23 has an uneven curved-surface shape along a contour of the six cylinders aligned in the X direction in a top view. That is, a part of the external wall 232 around the inter-bore wall 25 has an inwardly-concave curved surface, whereas another part of the external wall 232 around the bore central wall 26 has an outwardly-convex curved surface. The internal wall 241 of the external block 24 has also an uneven curved-surface shape which corresponds to the uneven curved-surface shape of the external wall 232. Accordingly, a gap between the internal wall 241 and the external wall 232 is nearly constant in an extensive direction (X direction) of the water jacket 22.

The water-jacket spacer 3 has an uneven curved-surface shape which corresponds to the uneven curved-surface shape of the internal wall 241 and the external wall 232 as well. The water-jacket spacer 3 is arranged inside the water jacket 22 and separates the flow passage of the cooling water inside the water jacket 22 into a bore-side passage 22A and an anti-bore-side passage 22B. The bore-side passage 22A is the passage which is close to the cylinder 21 in the radial direction of the cylinder 21. The anti-bore-side passage 22B is the passage which is positioned on the outside of the bore-side passage 22A and far from the cylinder 21.

The water-jacket spacer 3 performs regulating of the flowing of the cooling water inside the water jacket 22 when the water pump 11 operates (during compulsory circulation of the cooling water). Further, the water-jacket spacer 3 is provided with an expansive member 4 to suppress the natural convection of the cooling water from occurring when the water pump 11 stops. Hereafter, the water-jacket spacer 3 will be described specifically.

[Details of Water-Jacket Spacer]

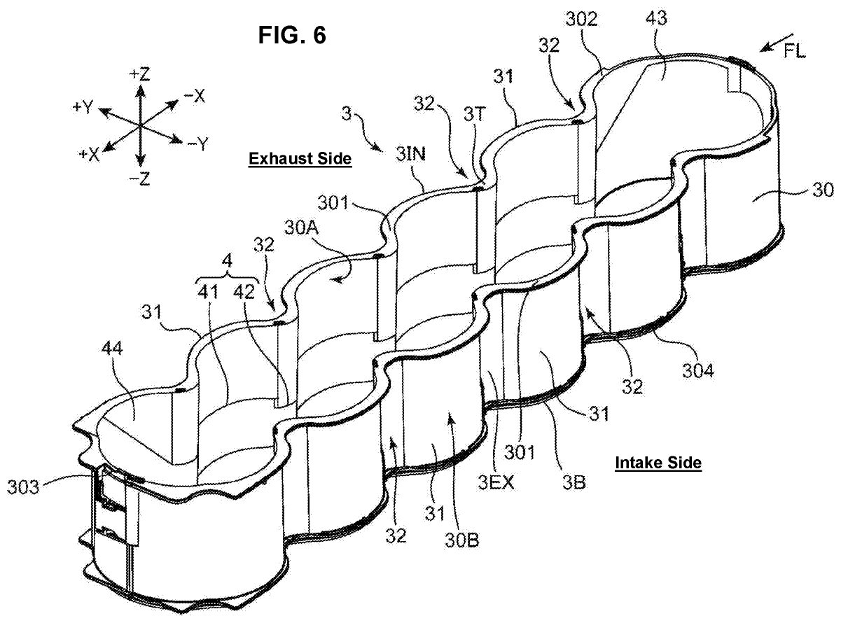

FIG. 6 is a perspective view of the water-jacket spacer 3. The water-jacket spacer 3 comprises a spacer body 30 and the expansive member 4 provided at the spacer body 30.

<Spacer Body>

The spacer body 30 has a cylindrical shape surrounding the cylinder line 21L, i.e., a convex surface and a concave surface which are respectively shaped along an outer-peripheral shape of the cylinder line 21L. The spacer body 30 includes an internal surface 30A facing the cylinders 21 (the internal block 23) and an external surface 30B positioned on an opposite side to the internal surface 30A and facing the external block 24 in a state where the spacer body 30 is arranged inside the water jacket 22.

An upper-end flange 301 is provided at an upper end (+Z end) of the spacer body 30, and a lower-end flange 304 is provided at a lower end (−Z end) of the spacer body 30. These flanges 301, 304 contribute to positioning maintenance of the water-jacket spacer 3 inside the water jacket 22, forming a desirable cooling-water flowing, and so on. An inlet flange 302 is formed at an upstream-end side, in the cooling-water flow direction shown by the arrow FL, of the upper-end flange 301. Meanwhile, a cutout portion 303 is formed at a downstream-end side of the upper-end flange 301. The cooling water is introduced into the water jacket arranged inside the cylinder head, not illustrated through this cutout portion 303.

The water-jacket spacer 3 comprises an intake-side spacer 3IN positioned on the +Y side and an exhaust-side spacer 3EX positioned on the −Y side. The intake-side spacer 3IN is a spacer portion arranged inside the intake-side jacket 22IN of the water jacket 2, and the exhaust-side spacer 3EX is another spacer portion arranged inside the exhaust-side jacket 22EX of the water jacket 2. The intake-side spacer 3IN and the exhaust-side spacer 3EX are respectively provided with the spacer body 30 and the extensive member 4.

The spacer body 30 comprises a central spacer portion 31 and an inter-bore spacer portion 32. The central spacer portion 31 is a portion which protrudes in a convex shape in the +Y direction or the −Y direction according to the external shape of the cylinder 21. Specifically, the central spacer portion 31 protrudes in the convex shape in the +Y direction at the intake-side spacer 3IN, and the central spacer portion 31 protrudes in the convex shape in the −Y direction at the exhaust-side spacer 3EX. The inter-bore spacer portion 32 is a portion which is curved in a concave shape in the −Y direction at the intake-side spacer 3IN or curved in the concave shape in the +Y direction at the exhaust-side spacer 3EX. The intake-side spacer 3IN and the exhaust-side spacer 3EX are connected to each other at the +X-side end portion and the −X-side end portion and these are integrated. In the state where the water-jacket spacer 3 is arranged inside the water jacket 22, the central spacer portion 31 faces the bore central wall 26 of the internal block 23 and the inter-bore spacer portion 32 faces the inter-bore wall 25 of the internal bock 23.

As described above, the water jacket 22 is formed in the drain (groove) shape such that it is partitioned by the external wall of the internal block 23 and the internal wall 241 of the external block 24 and its upper end is open. In the Y-direction section shown in FIGS. 4 and 5, the water jacket 22 has a U-shaped drain (groove) shape which is elongated in the vertical direction (the Z direction). The water-jacket spacer 3 is inserted into this water jacket 22, thereby separating the flow passage of the cooling water into the bore-side passage 22A and the anti-bore-side passage 22B inside the water jacket 22. The bore-side passage 22A is a passage which is formed between the internal surface 30A of the spacer body 30 and the external wall 232 of the internal block 23. The anti-bore-side passage 22B is another passage which is formed between the external surface 30B of the spacer body 30 and the internal wall 241 of the external block 24.

In the present embodiment, the water-jacket spacer 3 separates the flowing of the cooling water inside the water jacket 22 such that a mainstream of the cooling water is formed at the anti-bore-side passage 22B. That is, the flowing of the cooling water is formed aggressively in the anti-bore-side passage 22B (mainstream forming), whereas the flowing of the cooling water is regulated by the water-jacket spacer 3 in the bore-side passage 22A so that the flowing of the cooling water is not formed aggressively. This flowing regulating is executed because the cylinder 21 is so overcooled by the aggressive forming of the cooling-water flowing in the bore-side passage 22A which is close to the cylinder 21 that a cooling loss may be caused improperly.

Therefore, a lateral width of the bore-side passage 22A is set to be narrower than that of the anti-bore-side passage 22B. Specifically, referring to FIG. 4, the water-jacket spacer 3 is arranged in the water jacket 22 such that a relationship d2>d1 is satisfied, wherein d1 denotes the width (lateral width), in the Y direction, of the bore-side passage 22A and d2 denotes the width (lateral width), in the Y direction, of the anti-bore-side passage 22B. The Y-direction width d1 of the bore-side passage 22A is a gap between the internal surface 30A and the external wall 232. The Y-direction width d2 of the anti-bore-side passage 22B is a gap between the external surface 30B and the internal wall 241. For example, a value of the width d2 can be selected from a range from about 1.5-4 times of a value of the width d1.

When the width d2 is sufficiently larger than the width d1, the flow resistance of the cooling water of the anti-bore-side passage 22B becomes lower than that of the bore-side passage 22A. Therefore, in a case where the cooling water is supplied in the arrow FL direction at a specified supply pressure from the block-side inlet 14H (FIG. 3), the cooling-water flowing is formed in the anti-bore-side passage 22B primarily. In the bore-side passage 22A having the higher flow resistance of the cooling water, the flowing of the cooling water becomes relatively gentle. Accordingly, it can be suppressed that the cylinder 21 is excessively cooled.

<Expansive Member>

The expansive member 4 is a member which is provided at the internal surface 30A of the spacer body 30 and configured to be expandable according to an external factor. In the present embodiment, a material which is expandable according to its contacting with the water is applied to the expansive member 4. The expansive member 4 is made of cellulose-based sponge which is configured to recover to its pre-compressed state from its compressed state through its contacting with the cooling water flowing inside the water jacket 22. The cellulose-based sponge is a natural material which comprises cellulose made from pulp and natural fiber added as reinforcing fiber and is porous. Any other material than the cellulose-based sponge, such as the one made of foamed rubber which has been fixed in a compressed state by means of water-soluble binder, is applicable. Alternatively, a material which is expandable in response to the heat can be used.

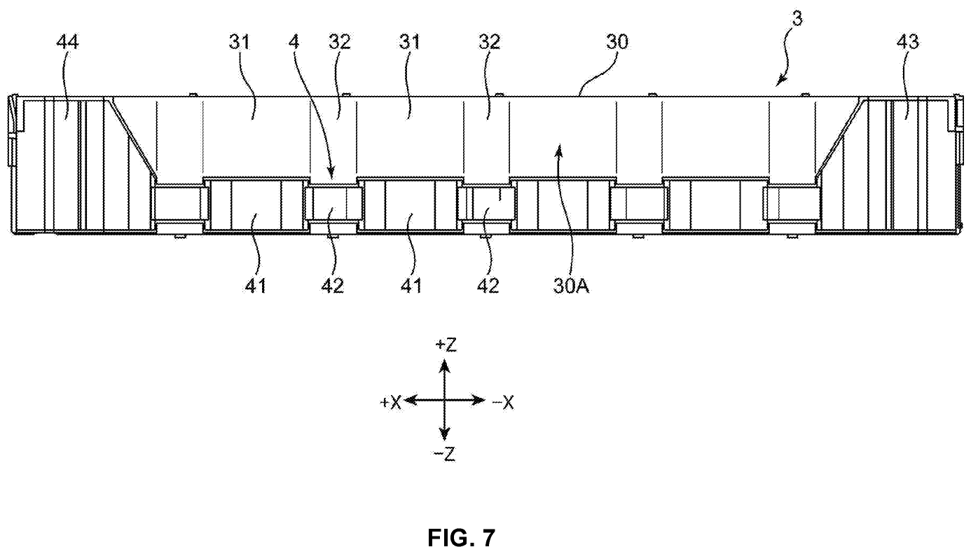

FIG. 7 is a side view of the internal surface 30A of the spacer body 30 where the extensive member 4 is provided. The expansive member 4 is provided at a lower part (−Z side), in the cylindrical-axis direction (Z direction), of the internal surface 30A of the spacer body 30. The expansive member 4 is further provided at the internal surface 30A of the spacer body 30 such that the expansive member 4 extends continuously over a range from an one-end side of the cylinder line 21L to the other-end side of the cylinder line 21L. The expansive member 4 comprises a concave-surface part 41 and a convex-surface part 42.

The concave-surface part 41 of the expansive member 4 is provided at the concave surface of the spacer body 30. The convex-surface part 42 of the expansive member 4 is provided at the convex surface of the spacer body 30. In the present embodiment, since the expansive member 4 is provided at the internal surface 30A, the concave surface is the internal surface 30A of the central spacer portion 31 and the convex surface is the internal surface 30A of the inter-bore spacer portion 32. Accordingly, the concave-surface part 41 is provided to adhere to a lower part of the central spacer portion 31, and the convex-surface part 42 is provided to adhere to a lower part of the inter-bore spacer portion 32.

The expansive member 4 is formed integrally with the spacer body 30 by an insert-molding process, for example. That is, the water-jacket spacer 3 can be manufactured by conducting the insert-molding process to the spacer body 30 in a state where the cellulose-based sponge is set in a shaping mold. Alternatively, the expansive member 4 may be attached to the internal surface 30A by a screw-attachment process, an adhesive agent, or the like in a state where the cellulose-based sponge is formed in a sheet-peace manner. The concave-surface part 41 of the expansive member 4 is set to have a slightly wider than the convex-surface part 42 in the Z-direction width. That is, the +Z end of the convex-surface part 42 is located at a lower level than the +Z end of the concave-surface part 41, and the −Z end of the convex-surface part 42 is located at a higher level than the −Z end of the concave-surface part 41. These parts 41, 42 are provided at the lower part of the internal surface 30A in a state where these parts 41, 42 are arranged closely to each other, having no gap therebetween, in the X direction. The arrangement of the expansive member 4 will be described specifically later.

[Flowing of Cooling Water and Performance of Expansive Member]

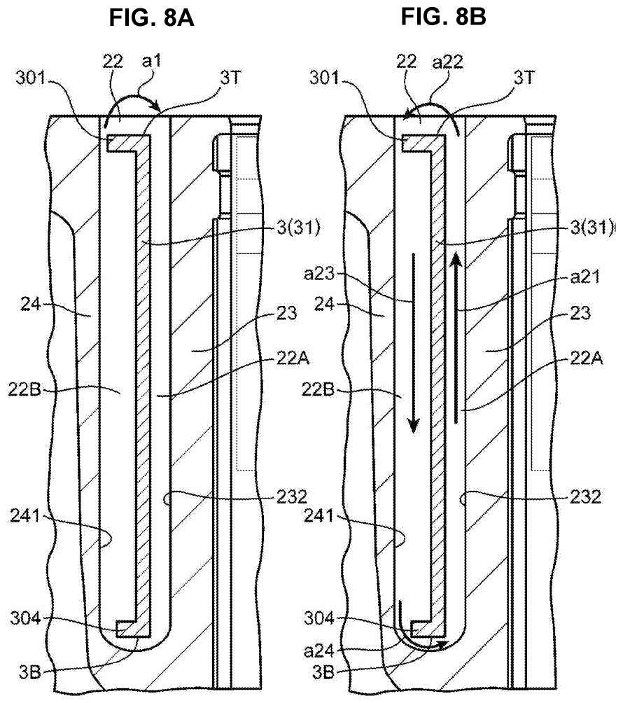

Subsequently, the flowing of the cooling water inside the water jacket 22 will be described. The flowing of the cooling water in a case where no expansive member is provided at the spacer body 30 will be described referring to FIGS. 8A, 8B first. FIG. 8A is a sectional view showing the flowing of cooling water when the water pump 11 operates, and FIG. 8B is a sectional view showing the flowing (natural convection) of the cooling water when the water pump 11 stops.

When the water pump 11 starts operating, the compulsory circulation of the cooling water starts in a circulation passage of the cooling water flowing in the engine body 10 as shown by the arrow FL of FIG. 2. As described previously, the water-jacket spacer 3 partitions the space inside the water jacket 22 such that the anti-bore-side passage 22B is wider than the bore-side passage 22A. Accordingly, since the flow resistance of the bore-side passage 22A is relatively large, the cooling water flows in the anti-bore-side passage 22B primarily when the water pump 11 operates.

The cooling water flows into the bore-side passage 22A from the anti-bore-side passage 2B such that the cooling water flows over the upper-end flange 301 of the spacer body 30 as shown by an arrow a1 in FIG. 8A. That is, the cooling water flows into the bore-side passage 22A from the anti-bore-side passage 22B through a gap between the internal wall 241 and the upper-end flange 301 and then flows in the he bore-side passage 22A. The amount of cooling water flowing in the bore-side passage 22A is smaller than that of cooling water flowing in the anti-bore-side passage 22B.

In the exhaust-side jacket 22EX having the inlet hole 28 of the cross drill 27, the flowing of the cooling water shown by the arrow a1 is promoted. That is, a suction force to suck the cooling water is generated at the inlet hole 28. This suction force forces the cooling water to be drawn into the bore-side passage 22A from the anti-bore-side passage 22B.

Meanwhile, when the water pump 11 stops because of an engine stop, execution of a water-stop mode during engine worming-up, or the like, the above-described compulsory circulation of the cooling water stops. Since the cooling water contacts the internal block 23 (the inter-bore wall 25 and the bore central wall 26) which is the cylinder wall during the engine stop, the temperature of the cooling water becomes relatively high. Meanwhile, the temperature of the cooling water in the anti-bore-side passage 22B becomes relatively low because of the heat exchange of the cooling water with the outside air. This kind of temperature difference of the cooling water may cause the natural convection occurring between the bore-side passage 22A and the anti-bore-side passage 22B.

As shown in FIG. 8B, the specific gravity of the cooling water in the bore-side passage 22A becomes lighter because its temperature increases, so that this cooling water rises in the bore-side passage 22A as shown by an arrow a21. To the contrary, the specific gravity of the cooling water in the anti-bore-side passage 22B becomes heavier because its temperature decreases, so that this cooling water rises in the anti-bore-side passage 22B as shown by an arrow a23. Consequently, a flow movement of the cooling water occurs at the upper end 3T of the water-jacket spacer 3 such that the cooling water flows into the anti-bore-side passage 22B from the bore-side passage 22A as shown by an arrow a22. Meanwhile, another flow movement of the cooling water occurs at the lower end 3B of the water-jacket spacer 3 such that the cooling water flows into the bore-side passage 22A from the anti-bore-side passage 22B as shown by an arrow a24. That is, there occurs the natural convection of the cooling water which flows as shown by the rows a21, a22, a23 and a24.

If the above-described natural convection of the cooling water occurs during the engine stop, the cylinder wall may be cooled. That is, if the movement of the cooling water is generated due to the natural convection occurring in the bore-side passage 22A, the heat of the bore central wall 26 and the inter-bore wall 25 is extracted, so that these walls 26, 25 may be overcooled. In this case, the warming-up state of the engine may not be maintained. This overcooling of the cylinder wall which is caused by the above-described natural convection of the cooling water is suppressed by the expansive member 4 provided at the internal surface 30A of the spacer body 30.

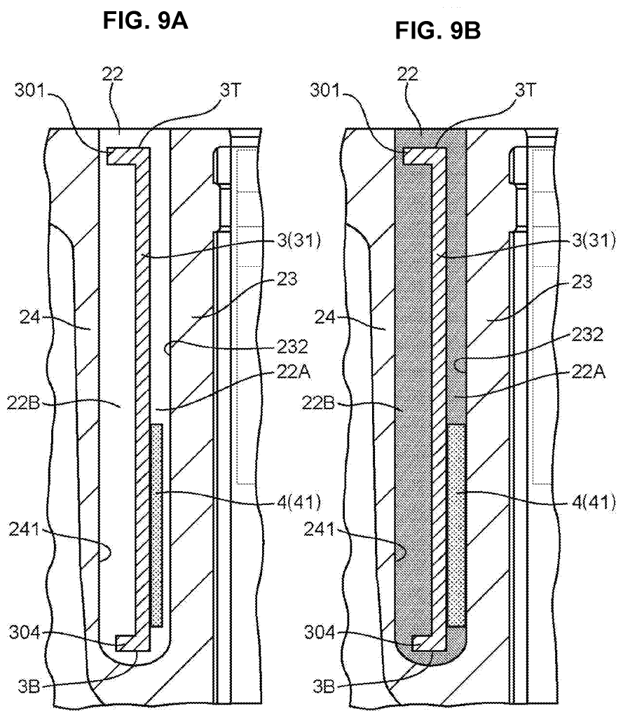

FIG. 9A is a sectional view showing a state before the expansive member 4 provided at the water-jacket spacer 3 expands, and FIG. 9B is a sectional view showing a state after the expansive member 4 expands. FIG. 9A shows a state where the water-jacket spacer 3 provided with the expansive member 4 is arranged inside the water jacket 22 when the cooling water has not been supplied inside the water jacket 22, for example, in an assembling process of the engine body. In this case, since the expansive member 4 has not expanded yet, a worker can easily assemble (insert) the water-jacket spacer 3 into the water jacket 22. Further, a gap is generated between the expansive member 4 and the external wall 232 of the internal block 23 after this assembling of the water-jacket spacer 3.

FIG. 9B shows a state after the cooling water has been supplied into the water jacket 22. The expansive member 4 expands through its contracting with the cooling water, so that the lateral width thereof increases. A right surface of the expansive member 4 contacts the external wall 232 of the internal block 23, so that a lower part of the bore-side passage 22A is substantially closed. Consequently, the natural convection of the cooling water which occurs during the engine stop or in the stop mode of the water pump 11, which is shown in FIG. 8B, is suppressed. That is, since the lower part of the bore-side passage 22A is closed by the expansive member 4, the flow movement of the cooling water, like the circulation through the bore-side passage 22A and the anti-bore-side passage 22B, is not generated. Accordingly, the cylinder 21 can be suppressed from being excessively cooled (i.e., overcooled) during the engine stop or the like.

[Arrangement of Expansive Member]

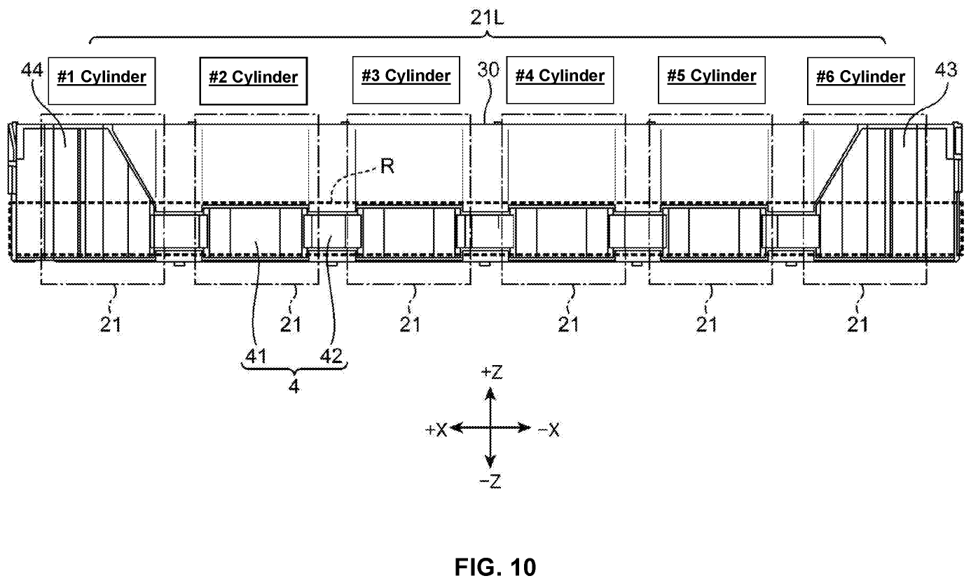

As described above, the expansive member 4 is provided at the internal surface 30A of the water-jacket spacer 3 such that it extends continuously over the range from the one-end side of the cylinder line 21L to the other-end side of the cylinder line 21L at the lower part, in the cylinder-axis direction, of the internal surface 30A of the water-jacket spacer 3. Hereafter, the arrangement of the expansive member 4 will be described specifically. FIG. 10 is a side view of the internal-surface side 30A of the water-jacket spacer 3, which shows relationships with cylinders 21. In FIG. 10, the cylinder line 21L including the #1-#6 cylinders 21 is shown by an imaginary line. The expansive member 4 comprises the concave-surface part 41, the convex-surface part 42, a first-end part 43 which faces the #6 cylinder 21 positioned at the −X-end side of the cylinder line 21L, and a second-end part 44 which faces the #1 cylinder 21 positioned at the +X-end side of the cylinder line 21L.

<Providing Expansive Member Continuously in Cylinder-Line Direction>

First of all, it is required in order to perfectly suppress the natural convection of the cooling water that the expansive member 4 is provided at the water-jacket spacer 3 such that it extends continuously over the range from the one-end side (+X) of the cylinder line 21L to the other-end side (−X) of the cylinder line 21L. This is because if an expansive-member missing part where no expansive member is provided exists in the X direction, the natural convection of the cooling water shown in FIG. 8B may be generated by way of this missing part.

Therefore, according to the expansive member 4 of the present embodiment, the concave-surface part 41 and the convex-surface part 42 are continuously provided to be close to each other, having no gap therebetween, in the X direction in an area which faces the #2 cylinder 21-the #5 cylinder 21. The second-end part 44 facing the #1 cylinder 21 is provided at the +X side of this continuous body of the concave-surface part 41 and the convex-surface part 42, and the first-end part 43 facing the #6 cylinder 21 is provided at the −X side of this continuous body of the concave-surface part 41 and the convex-surface part 42. Accordingly, the expansive member 4 which extends continuously over an entire length of the area facing the #1-#6 cylinders 21 is provided. Thus, by arranging the water-jacket spacer 3 provided with the above-described expansive member 4 inside the water jacket 22, the expansive member 4 which has expanded so fills the gap of the bore-side passage 22A over the entire length of the cylinder line 21L that the natural convection of the cooling water can be suppressed from occurring.

<Providing Expansive Member at Lower Part in Cylindrical-Axis Direction>

Next, the meaning of arranging the expansive member 4 at the lower part, in the cylinder-axis direction, of the internal surface 30A of the spacer body 30 will be described. In order to suppress the natural convection of the cooling water between the bore-side passage 22A and the anti-bore-side passage 22B, it may be enough to arrange the expansive member 4 in any one of the bore-side passage 22A and the anti-bore-side passage 22B so as to close the circulation passage of the cooling water. However, if the expansive member 4 is arranged in the anti-bore-side passage 22B (on the side of the external surface 30B of the spacer body 30), the movement (flowing) of the cooling water in the anti-bore-side passage 22B stagnates, so that the cooling water flows in the bore-side passage 22A. In this case, since the cylinder wall including the inter-bore wall 25 and the bore central wall 26 is cooled excessively (overcooled), this situation is not good. Accordingly, it is preferable that the expansive member 4 be arranged in the bore-side passage 22A (on the side of the internal surface 30A of the spacer body 30).

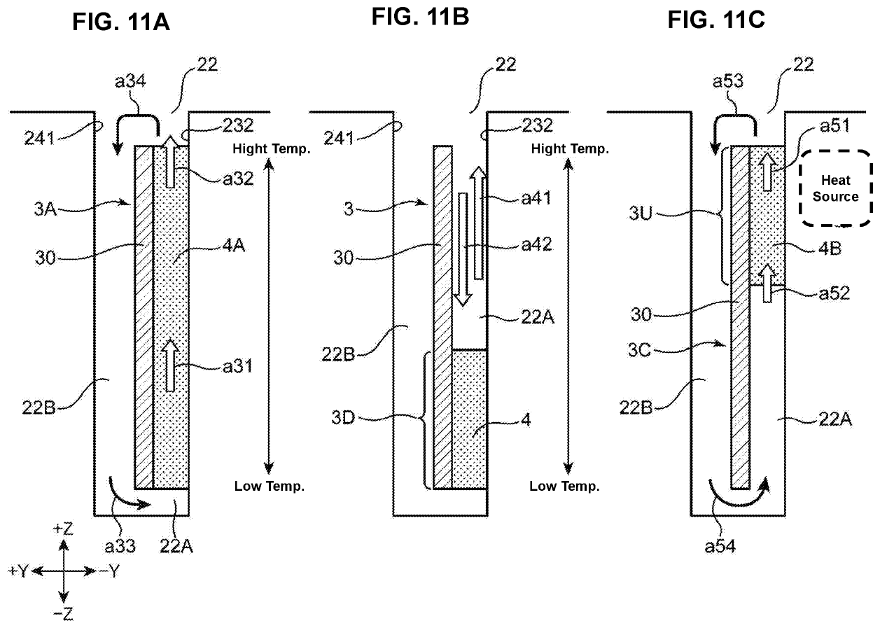

The place where the expansive member 4 is to be arranged at the bore-side passage 22A will be described referring to FIG. 11A-11C. FIG. 11A a diagram showing the flowing of the cooling water when the water pump stops in a case where a water-jacket spacer 3A provided with an expansive member 4A of a comparative example is used. FIG. 11A shows an example where the expansive member 4A is provided to extend over the entire length of the spacer body 30 in the Z direction.

The cellulose-based sponge used for the expansive member 4A is not a perfect impermeable material but allows the water to pass through it to a certain extent. Further, the cooling water of the bore-side passage 22A has a tendency that the temperature of its upper side is higher than that of its lower side. Accordingly, the cooling water is going to rise inside the bore-side passage 22A. In the comparative example of FIG. 11A, even if the flow resistance of the bore-side passage 22A becomes high because of the entire-length arrangement of the expansive member 4A, the flow resistance is constant over the entire length, in the Z direction, of the bore-side passage 22A. Therefore, as shown by arrows a31, a32 in the figure, once the water flowing penetrating the expansive member 4A is generated, the natural convection occurs. That is, there occurs the flowing of the cooling water (an arrow a33) which is directed from a lower end of the anti-bore-side passage 22B toward the bore-side passage 22A at the lower side of the spacer body 30 by being drawn by the flowing shown by the arrow a31. At the upper part of the spacer body 30, meanwhile, there occurs the flowing of the cooling water (an arrow a34) which is directed from the bore-side passage 22A toward the anti-bore-side passage 22B having the lower flow resistance. Thus, the natural convection of the cooling water circulating as shown by the arrows a31, a32, a34, a33 may occur even though this circulating flowing is not so strong.

FIG. 11B shows the flowing of the cooling water in a case where the spacer body 30 provided with the expansive member 4 of the present embodiment is used. In the present embodiment, the expansive member 4 is provided at a lower part 3D of the spacer body 30. Therefore, the flow resistance of the bore-side passage 22A at the lower part 3D of the spacer body 30 where the expansive member 4 is provided is high, whereas the flow resistance of the bore-side passage 22A at an upper part of the spacer body 30 where no expansive member 4 is provided is low. That is, the flow resistance of the bore-side passage 22A is not constant in the Z direction but there exists a gap in the flow resistance.

In the case of the present embodiment shown in FIG. 11B, the circulating flowing of the cooling water which is generated only in the upper part of the bore-side passage 22A occurs primarily. That is, even if the flowing of the cooling water (an arrow a41) which is going to rise because of the heat exchange with the cylinder wall occurs, this flowing does not reach the ant-bore-side passage 22B and becomes the flowing of the cooling water (an arrow a42) which lowers in the upper part of the bore-side passage 22A. If the expansive member 4 is not arranged at the lower part 3D of the bore-side passage 22A, once the flowing shown by the arrow a41 occurs, a circulating passage where the water flowing goes in to the upper end of the anti-bore-side passage 22B and then returns to the bore-side passage 22A from the lower end of the anti-bore-side passage 22B is generated. According to the present embodiment, however, since the expansive member 4 is provided, the flow resistance of the above-described circulating passage becomes high. Accordingly, when the rising flow shown by the arrow a41 is generated, the cooling water does not flow toward the upper end of the anti-bore-side passage 22B which is a higher flow-resistance route, so that the lowering flow shown by the arrow a42 is generated. In this case, since the cooling water substantially stays in the upper part of the bore-side passage 22A, the heat exchange with the cylinder wall decreases. That is, the natural convection of the cooling water is so suppressed from occurring that the heat retaining property of the cylinder wall can be improved.

Herein, while it may be considered that the expansive member 4 is arranged only in the upper part of the bore-side passage 22A, this arrangement cannot suppress the natural convection from occurring. FIG. 11C shows the flowing of the cooling water in a case where a water-jacket spacer 3C provided with an expansive member 4B of another comparative example. In the comparative example of FIG. 11C, the expansive member 4B is provided at an upper part 3U of the spacer body 30. This upper part 3U is an area which faces a heat-source area at the cylinder block 2. This heat-source area is an area where the heat is generated through the combustion inside the cylinder 21.

In this case, since the expansive member 4B faces the above-described heat-source area, the flowing of the cooling water (an arrow a51) which is going to rise in the expansive member 4B is generated. There occurs the flowing of the cooling water (an arrow a52) which flows into the expansive member 4B from the lower part of the bore-side passage 22A by being drawn by the flowing shown by the arrow a51. That is, the expansive member 4B becomes a starting point of occurrence of the cooling-water flowing. Further, the flow resistance of another area than the area where of the expansive member 4B is provided is relatively low. Accordingly, there occurs the flowing of the cooling water (an arrow a54) which is directed from the bore-side passage 22A toward the anti-bore-side passage 22B at the upper-end side of the spacer body 30. At the lower-end side of the spacer body 30, meanwhile, there occurs the flowing of the cooling water (an arrow a54) which is directed from the lower end of the anti-bore-side passage 22B toward the bore-side passage 22A. Accordingly, the natural convection of the cooling water circulating as shown by the arrows a51, a53, a54, a52 may occur. Therefore, it is preferable that the expansive member 4 be provided at the lower part 3D of the spacer body 30.

The lower part of the internal surface 30A of the spacer body 30 where the expansive member 4 is provided according to the present embodiment which is shown in FIG. 11B is an area which faces a portion of the internal peripheral wall 231 of the internal block 23 which is located at the lower level than the above-described heat-source area. Thereby, as show in FIG. 11B, the cooling water heated in the heat-source area can be made to stay in the upper part of the bore-side passage 22A which faces the heat-source area. Accordingly, the heat retaining property of the heat-source area can be improved when the water pump 11 stops.

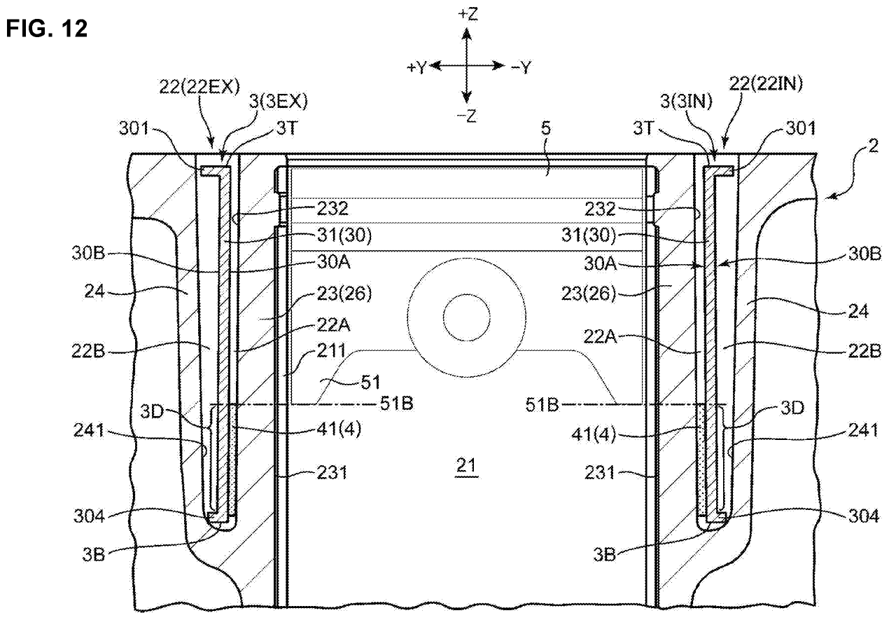

Specifically, the above-described lower part 3D can be set in a relationship with the piston arranged in the cylinder 21. FIG. 12 is a sectional view showing a preferred arrangement position of the expansive member 4. A piston 5 is provided to reciprocate in the Z direction inside the cylinder 21. The piston 5 includes a skirt portion 51 at its lower side. The lower part 3D of the internal surface 30A can be set at an area which faces a portion of the external wall 232 of the internal block 23 which is located below a lower end 51B of the skirt portion 51 of the piston 5 is positioned at a top dead center.

FIG. 12 shows an exemplified embodiment in which the expansive member 4 is provided in an area extending from a point on an extension line of the lower end 51B of the skirt portion 51 to the lower end of the spacer body 30, that is—in all area of the lower part 3D. In general, the area from the upper end of the cylinder 21 to the lower end 51B of the skirt portion 51 of the piston 5 positioned at the top dead center becomes the heat-source area where the heat caused by the combustion inside the cylinder 21 is generated. Accordingly, the heat retaining property of this heat-source area can be improved by providing the expansive member 4 at the lower part 3D so as to make the cooling water stay at a portion of the bore-side passage 22A which faces the heat-source area.

<Other Features>

Referring to FIG. 10, the two parts of the expansive member 4 which are provided to face the both cylinders located at the one-end side of the cylinder line 21L and the other-end side of the cylinder line 21L are respectively provided at the lower part 3D and an upper part which is located above the lower part 3D. That is, the expansive member 4 is configured such that its first-end part 43 facing the #6 cylinder 21 positioned at the −X-end side of the cylinder line 21L and its second-end part 44 facing the #1 cylinder 21 positioned at the +X-end side of the cylinder line 21L are provided not only at the lower part 3D but at the upper part which is located above the lower part 3D.

The #1 cylinder 21 and the #6 cylinder 21 positioned at the both ends of the cylinder line 21L do not receive the heat influence of the combustion very much, compared with the other cylinders, because they are positioned at the both ends of the cylinder line 21L. Specifically, the #1 cylinder 21 is adjacent only to the #2 cylinder 21 and the #6 cylinder 21 is adjacent only to the #5 cylinder 21, and these #1, #6 cylinders 21 are not interposed between the two cylinders unlike the other cylinders. Therefore, these #1, #6 cylinders 21 tend to have the lower temperature than the other #2-#5 cylinders 21. It is avoided to make the cylinder wall (internal block 23) partitioned the #1 cylinder 21 and the #6 cylinder 21 contact the cooling water by providing the expansive member 4 not only at the lower part 3D but at the upper part. Thereby, the heat retaining of the #1 cylinder 21 and the #6 cylinder 21 can be achieved.

The thickness, in a direction (Y direction) perpendicular to the cylinder-line direction (X direction) in a horizontal plane, of the expansive member 4 is selected according to a lateral width of the bore-side passage 22A. It is required that there occurs no gap between the expansive member 4 which has expanded and the external wall 232 of the internal block 23 in order to perfectly suppress the natural convection of the cooling water. Therefore, it is preferable that the thickness of the expansive member 4 which has not expanded yet be set so that the expansive member in its expansion state can close the gap between the inter-bore wall 25 and the bore central wall 26 and the internal surface 30A of the spacer body 30 (see FIG. 9B).

Herein, in the present embodiment, the water-jacket spacer 3 is arranged inside the water jacket 22 such that the Y-direction width (lateral width) d1 of the bore-side passage 22A is narrower than the Y-direction width d2 of the anti-bore-side passage 22B. This contributes to the suppression of the natural convection of the cooling water as well. That is, this structure is configured such that the flowing of the cooling water is not generated inside the bore-side passage 22A substantially because of the relationship of d2>d1. Accordingly, the suppression effect of the natural convection of the cooling water by providing the expansive member 4 is achieved properly.

### MODIFIED EXAMPLE

The present invention should not be limited to the above-described embodiment and any other modifications or improvements may be applied within the scope of a spirit of the present invention.

(1) The above-described embodiment exemplified the case where the expansive member 4 is provided at the internal surface 30A of the spacer body 30 such an upper end of the expansive member 4 is located on the extension line of the lower end 51B of the skirt portion 51 (FIG. 12). In place of this case, the expansive member 4 may be provided such that its upper end is located at a lower level than the extension line of the lower end 51B of the skirt portion 51. Further, the expansive member 4 may be provided such that its upper end is located slightly above the extension line of the lower end 51B of the skirt portion 51.

(2) The above-described embodiment exemplified the case, as shown in FIGS. 7 and 10, where the Z-direction width of the convex-surface part 42 of the expansive member 4 is narrower than that of the concave-surface part 41. Alternatively, the both Z-direction widths of these surface parts 41, 42 may be set to be equal. Further, while the above-described embodiment exemplified the case where these surface parts 41, 42 are provided over the entire width, in the Z direction, of the spacer body 30, these surface parts 41, 42 may be provided only at the lower part of the spacer body 30.

(3) Regarding the bore-side passage 22A and the anti-bore-side passage 22B which are partitioned by the water-jacket spacer 3 in the above-described embodiment, the relationship d2>d1 is satisfied such that the flowing of the cooling water is primarily formed in the anti-bore-side passage 22B as shown in FIG. 4. However, this was merely one example, and the respective widths of these passages 22A, 22B, the shape of the water-jacket spacer 3, and others can be set properly according to a cooling control strategy of the engine body 10.

What is claimed is:

1. A cooling structure of an engine, comprising:
an engine block provided with a wall surface which partitions a cylinder line including plural cylinders arranged in a specified direction and a water jacket provided to surround the cylinder line and allow cooling water to flow therein; and
a water-jacket spacer arranged inside the water jacket and provided to regulate flowing of the cooling water in the water jacket,
wherein said water-jacket spacer comprises a spacer body which has a shape along an outer-peripheral shape of said cylinder line and includes an internal surface facing the cylinders and an external surface positioned on an opposite side to said internal surface, and
an expansive member configured to be expandable according to an external factor is provided at the internal surface of the spacer body of said water-jacket spacer such that the expansive member extends continuously over a range from an one-end side of said cylinder line to the other-end side of said cylinder line at a lower part, in a cylinder-axis direction, of the internal surface of the spacer body.

2. The cooling structure of the engine of claim 1, further comprising a piston provided to reciprocate in the cylinder-axis direction inside each cylinder and including a skirt portion, wherein said lower part, in the cylinder-axis direction, of the internal surface of the spacer body where said expansive member is an area which faces a portion of said wall surface of the engine block which is located below a lower end of the skirt portion of said piston when the piston is positioned at a top dead center.

3. The cooling structure of the engine of claim 2, wherein said engine block comprises an inter-bore wall which is interposed between adjacent cylinders and a bore central wall which is another part of a peripheral wall of each cylinder than said inter-bore wall, and thickness, in a direction perpendicular to said specified arrangement direction of the plural cylinders in a horizontal plane, of said expansive member in an expanded state of the expansive member is set such that the expansive member closes a gap between said internal surface of the spacer body of the water-jacket spacer and said inter-bore wall and said bore central wall of the engine block.

4. The cooling structure of the engine of claim 3, wherein said water-jacket spacer is configured to separate a flow passage of the cooling water inside the water jacket into a bore-side passage which is close to the cylinders and an anti-bore-side passage which is far from the cylinders, and said water-jacket spacer is arranged inside the water jacket such that a lateral width of said bore-side passage is narrower than that of said anti-bore-side passage.

5. The cooling structure of the engine of claim 4, wherein a part of said expansive member which is provided to face the both cylinders located at said one-end side of the cylinder line and said other-end side of the cylinder line is provided not only at said lower part, in the cylinder-axis direction, of the internal surface of the spacer body but at an upper part of the internal surface of the spacer body which is located above said lower part.

6. The cooling structure of the engine of claim 1, wherein said engine block comprises an inter-bore wall which is interposed between adjacent cylinders and a bore central wall which is another part of a peripheral wall of each cylinder than said inter-bore wall, and thickness, in a direction perpendicular to said specified arrangement direction of the plural cylinders in a horizontal plane, of said expansive member in an expanded state of the expansive member is set such that the expansive member closes a gap between said internal surface of the spacer body of the water-jacket spacer and said inter-bore wall and said bore central wall of the engine block.

7. The cooling structure of the engine of claim 1, wherein said water-jacket spacer is configured to separate a flow passage of the cooling water inside the water jacket into a bore-side passage which is close to the cylinders and an anti-bore-side passage which is far from the cylinders, and said water-jacket spacer is arranged inside the water jacket such that a lateral width of said bore-side passage is narrower than that of said anti-bore-side passage.

8. The cooling structure of the engine of claim 1, wherein a part of said expansive member which is provided to face the both cylinders located at said one-end side of the cylinder line and said other-end side of the cylinder line is provided not only at said lower part, in the cylinder-axis direction, of the internal surface of the spacer body but at an upper part of the internal surface of the spacer body which is located above said lower part.

9. The cooling structure of the engine of claim 2, wherein said water-jacket spacer is configured to separate a flow passage of the cooling water inside the water jacket into a bore-side passage which is close to the cylinders and an anti-bore-side passage which is far from the cylinders, and said water-jacket spacer is arranged inside the water jacket such that a lateral width of said bore-side passage is narrower than that of said anti-bore-side passage.

10. The cooling structure of the engine of claim 2, wherein a part of said expansive member which is provided to face the both cylinders located at said one-end side of the cylinder line and said other-end side of the cylinder line is provided not only at said lower part, in the cylinder-axis direction, of the internal surface of the spacer body but at an upper part of the internal surface of the spacer body which is located above said lower part.

11. The cooling structure of the engine of claim 3, wherein a part of said expansive member which is provided to face the both cylinders located at said one-end side of the cylinder line and said other-end side of the cylinder line is provided not only at said lower part, in the cylinder-axis direction, of the internal surface of the spacer body but at an upper part of the internal surface of the spacer body which is located above said lower part.

12. The cooling structure of the engine of claim 6, wherein said water-jacket spacer is configured to separate a flow passage of the cooling water inside the water jacket into a bore-side passage which is close to the cylinders and an anti-bore-side passage which is far from the cylinders, and said water-jacket spacer is arranged inside the water jacket such that a lateral width of said bore-side passage is narrower than that of said anti-bore-side passage.

13. The cooling structure of the engine of claim 6, wherein a part of said expansive member which is provided to face the both cylinders located at said one-end side of the cylinder line and said other-end side of the cylinder line is provided not only at said lower part, in the cylinder-axis direction, of the internal surface of the spacer body but at an upper part of the internal surface of the spacer body which is located above said lower part.

14. The cooling structure of the engine of claim 7, wherein a part of said expansive member which is provided to face the both cylinders located at said one-end side of the cylinder line and said other-end side of the cylinder line is provided not only at said lower part, in the cylinder-axis direction, of the internal surface of the spacer body but at an upper part of the internal surface of the spacer body which is located above said lower part.
